(19) United States
(12) Patent Application Publication
(10) Pub. No.: US 2010/0316978 A1
(43) Pub. Date: Dec. 16, 2010

(54) Mobile, wireless, hands-free visual/verbal trans-language communication system (acronym:V2V XLC System)

(76) Inventor: James David Goode, Pipe Creek, TX (US)

Correspondence Address: James David Goode, 829 Mountain View Lane, Pipe Creek, TX, 78063-5587, US

(21) Appl. No.: 12/801,467

(22) Filed: Jun. 8, 2010

Related U.S. Application Data
(60) Provisional application No. 61/268,161, filed on Jun. 9, 2009.

(51) Int. Cl. G09B 21/00

(52) U.S. Cl. 434/112

(57) ABSTRACT

The V2V XLC system is a mobile, wireless trans-language communication (XLC) system enabling direct, real-time communications between people conversing in different languages, including visual (e.g. American Sign Language) and verbal (e.g. English) languages. The acronym “X-L-C” stands for Trans Language Communication. The FREEDOM XLC model enables Deaf and Hard of Hearing (DHH) users with real-time bidirectional communications capability to facilitate their interaction with the hearing society. A Freedom client using a Visual language (e.g. ASL) can converse directly with someone using a Verbal language (e.g. English) and vice versa. This is referred to as V2V communications. Equipped with wireless mobility, it is lightweight and “transparent”, providing anytime/anywhere availability. The Freedom features hands-free operation and multimedia interaction, including digital sign, video, synthesized voice and text. With cell phone size portability and direct access to wireless services, Freedom provides DHH users with an all-in-one PERSONAL COMMUNICATION DEVICE.

### CROSS-REFERENCE TO RELATED APPLICATIONS

This application claims the benefit of U.S. Provisional application No. 61/268,161, filed on Jun. 9, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor to which this invention pertains generally falls under U.S. patent Group II classifications covering digital communications, electrical and computer arts, and more specifically to devices, methods, systems and computer program products providing mobile, wireless, real-time digital bilingual, bilateral linguistic conversion.

The Freedom XLC model of this invention, designed for Deaf and Hard of Hearing (DHH) users, provides this bilateral linguistic digital conversion capability between visual languages (e.g. American Sign Language) and verbal languages (e.g. English).

There continues to be a flow of innovative products that advance the communication capability between the Deaf and hearing communities. With the establishment of formal visual languages, such as American Sign Language (ASL), digital technology has been applied to enhance various aspects of this bilingual communication process.

Examples of patented capabilities include:

Encoding of sign-language hand motion and subsequent conversion to text

Encoding of audible speech and subsequent conversion to animated sign and text

Visual encoding of real-time sign language, with accompanying text and/or audio

All these inventions provide value within a limited scope of application. However, each of these solutions is either tethered to a larger, non-mobile system, or, if mobile, typically constrains the Deaf user to a text communication interface mode.

These limitations inhibit DHH individuals from fully accessing and engaging in mainstream society, socially, educationally and economically. At a 40% unemployment rate, economic engagement is not happening for today's Deaf adults. Equipped with 3rd grade reading skills, economic engagement prospects for the next-gen 18 year old are bleak.

### BRIEF SUMMARY OF THE INVENTION

The V2V XLC system is a mobile, wireless trans-language conversion (XLC) system providing a method and apparatus for direct, real-time communications between people conversing in different languages, including visual (e.g. American Sign Language) and verbal (e.g. English) languages. The acronym “X-L-C” stands for Trans Language Communication.

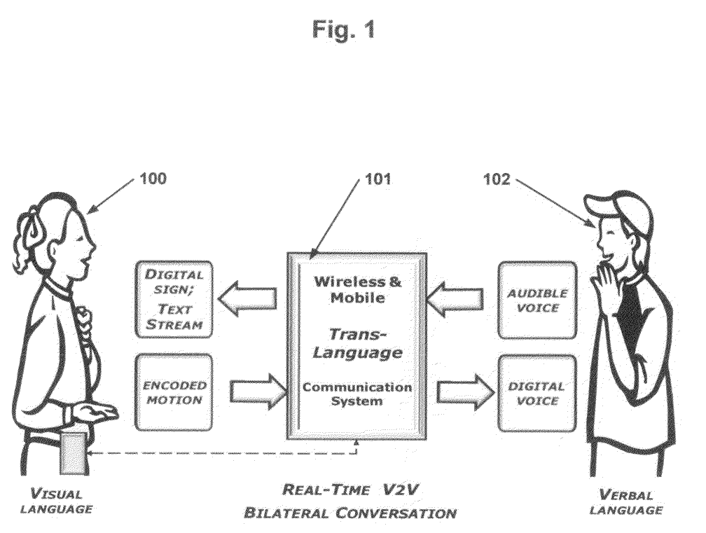

Referencing FIG. 1/9, the FREEDOM XLC model 101 enables DHH users with real-time bidirectional communications capability to facilitate their interaction with the hearing society. A Freedom client 100 using a Visual language can converse directly with someone using a Verbal language 102 and vice versa. This is referred to as V2V communications.

Equipped with wireless mobility, it is lightweight and “transparent”, providing anytime/anywhere availability to DHH users. The Freedom features hands-free operation and multimedia interaction, including digital sign, video, synthesized voice and text. With cell phone size portability and direct access to wireless services, Freedom provides the all-in-one PERSONAL COMMUNICATION DEVICE for DHH users.

The FREEDOM XLC model utilizes an “on-board” PERSONAL POSITIONING SUBSYSTEM (PPS) to encode visual-language related anatomical motion (i.e. motion capture) and wirelessly transmits the encoded data to the TRANS LANGUAGE CONVERSION CENTER (XLCC) for conversion to an encoded verbal-language equivalent. The encoded verbal-language equivalent is processed through a digital voice synthesizer and presented in an audible format.

The conversion from verbal-language to visual-language reverses this process, utilizing the Freedom's digital audio input as the data source for conversion and providing the DHH user with visual-language equivalency displayed in the form of text and/or digital sign language.

Equipped with FREEDOM XLC capability, DHH individuals are self-enabled to impact their quality of life through social, educational and career engagement within the hearing-majority society.

There are at least four (4) general V2V intercommunication scenarios in which the XLC system may play a value-adding role. These scenarios are included to provide additional clarity regarding the applications of the present invention and are not intended to limit the scope of the present invention:
1. SCENARIO A: VISUAL/VERBAL: XLC user utilizing a visual language (e.g. ASL), communicating with another person(s) using a verbal language (e.g. English), “face-to-face” or remotely via wireless digital services
2. SCENARIO B: VISUAL/VISUAL: XLC user utilizing a visual language (e.g. ASL), communicating with another XLC user using a different visual language (e.g. JSL), “face-to-face” or remotely via wireless digital services
3. SCENARIO C: VERBAL/VERBAL: XLC user utilizing a verbal language (e.g. English), communicating with another person(s) using a different verbal language (e.g. Japanese), “face-to-face” or remotely via wireless digital services
4. SCENARIO D: XLC AS STAND-ALONE: XLC user in stand-alone mode for uses such as entertainment and education, such as self-taught language, training, education and development courses

NOTE: XLC system may also support standard verbal/verbal, same language communication currently available using other digital devices (e.g. cell phone)

NOTE: XLC system may also support “one-to-many-to-one” communication scenarios, such as may be required in conferencing and educational settings

### BRIEF DESCRIPTION OF THE SEVERAL VIEWS OF THE DRAWING

The following is a listing of figures with a corresponding brief statement regarding content:

1. FIG. 1/9 is a depiction of a bilateral conversation between a DHH individual and hearing individual via Freedom XLC

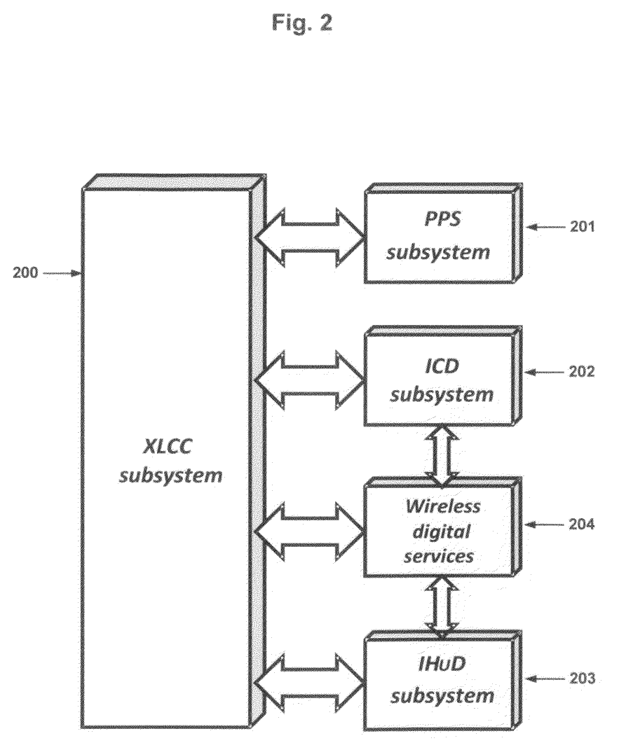

2. FIG. 2/9 is a BLOCK DIAGRAM of major subsystems of the Freedom XLC system

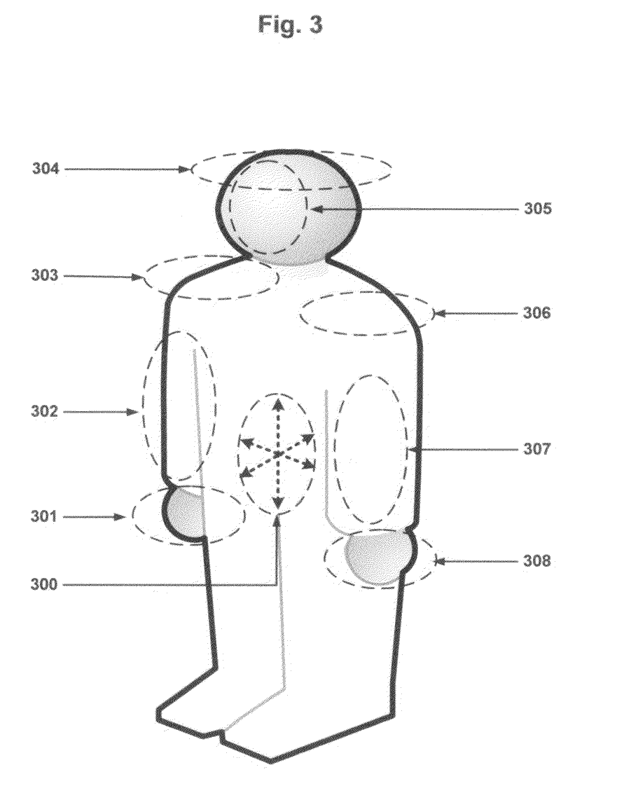

3. FIG. 3/9 is a depiction of the PPS subsystem pre-mapped anatomical tracking zones and virtual positioning matrix

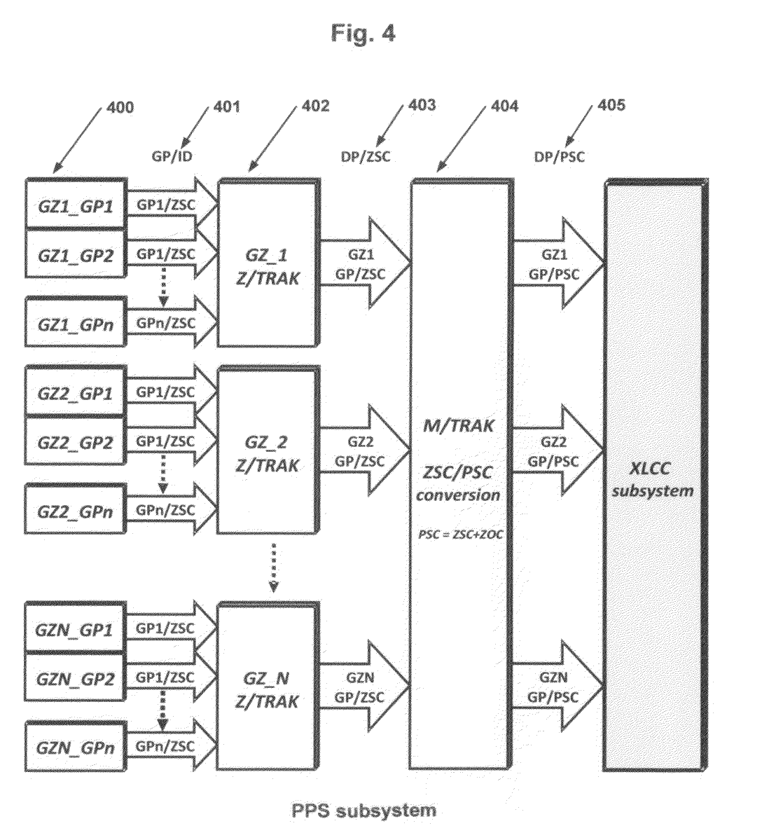

4. FIG. 4/9 is a BLOCK DIAGRAM of depicting the tracking data flow & formatting as it is processed through the PPS subsystem

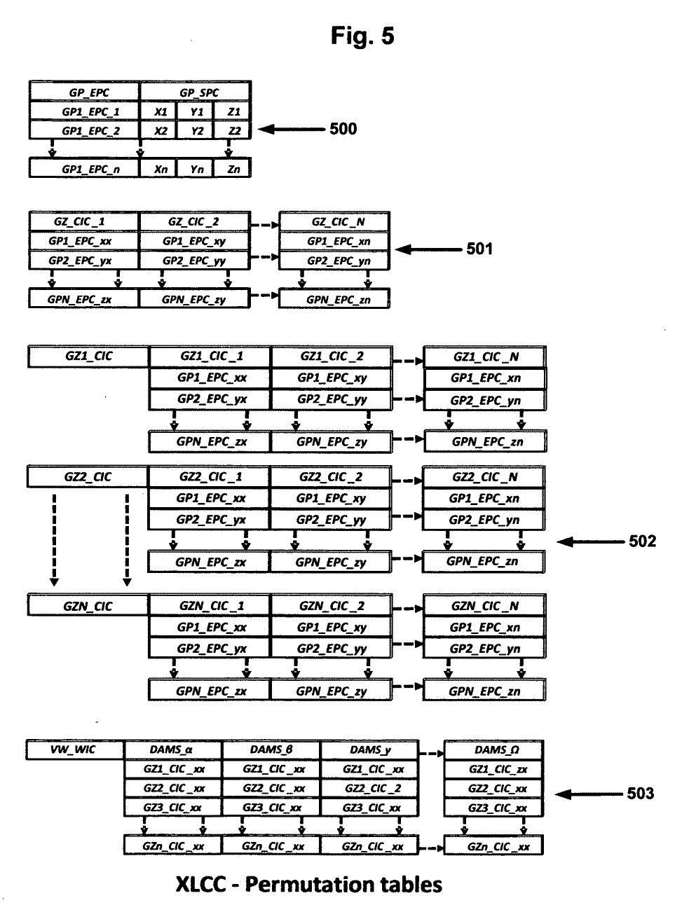

5. FIG. 5/9 is a sequence of tables depicting the “standard” permutation tables used by the XLCC subsystem for trans-language conversion

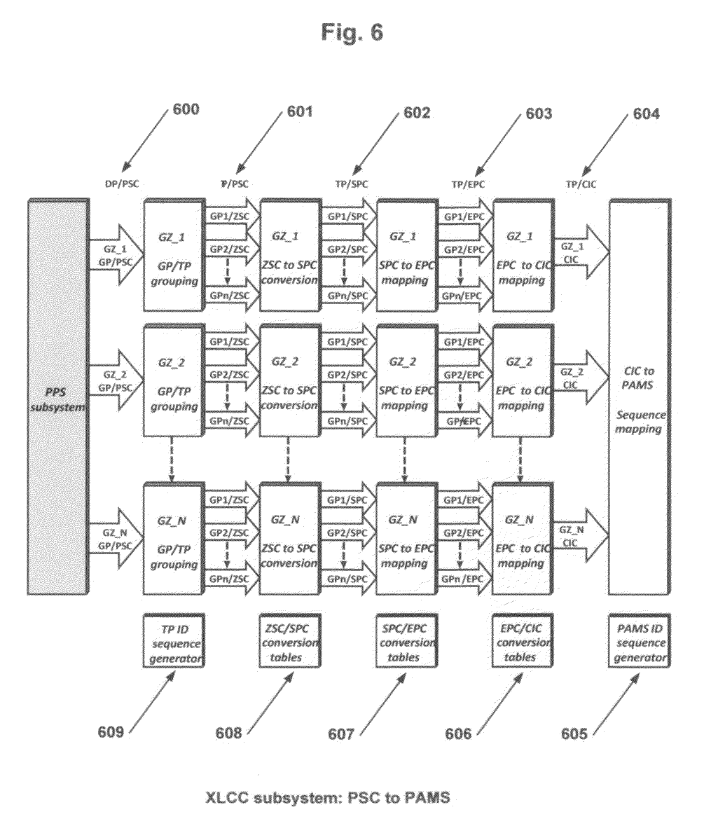

6. FIGS. 6/9, 7/9 and 8/9 is a BLOCK DIAGRAM of depicting data flow, formatting and conversion process as it is processed through the XLCC subsystem

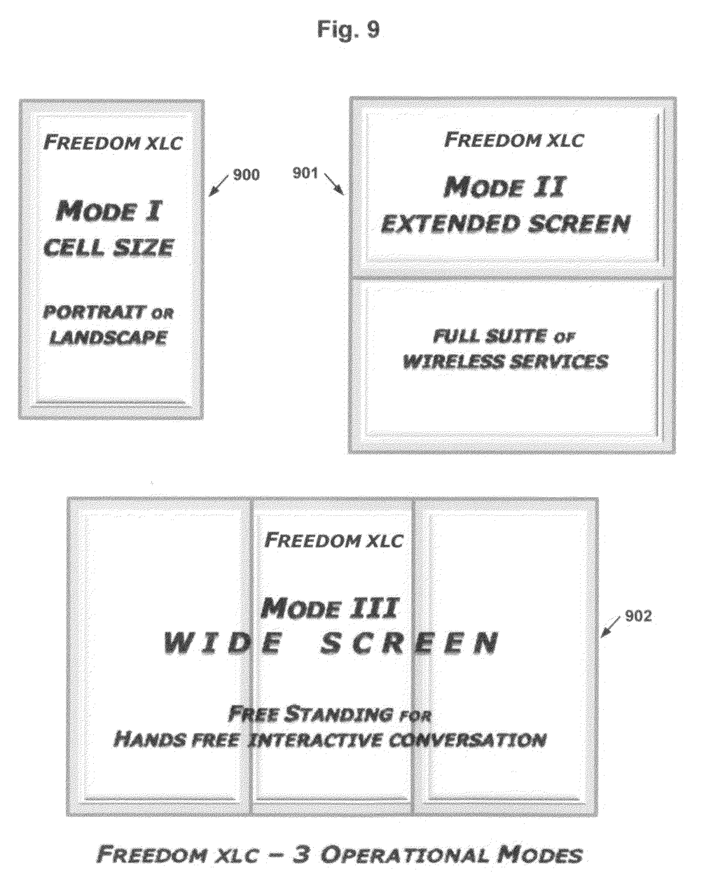

7. FIG. 9/9 is a depiction of the ICD physical design and modes of operation

### DETAILED DESCRIPTION OF THE INVENTION

The V2V XLC system is language configurable, as well as functionally and physically modular and is comprised of four major subsystems. Referencing FIG. 2/9, these include:
1. PPS subsystem 201: primary function is to wirelessly track and digitally encode the XLC user's anatomic motion as it relates to visual language communication (e.g. ASL) and to wirelessly transmit tracking data to the XLCC subsystem 200 for processing.
2. XLCC subsystem 200: primary function is trans-language digital bi-directional conversion: visual to verbal; visual to visual; verbal to verbal. For conversion from Visual Language (VL), the XLCC utilizes the positioning data from the PPS subsystem 201 as an input and converts VL dynamics into a verbal language equivalent output, digitally encoded for wireless transmission to the ICD subsystem 202. The conversion from verbal language to visual language reverses this process, utilizing the user's digital-audio input as the data source for conversion and converts into VL equivalent output, digitally encoded for wireless transmission to the ICD subsystem 202.
3. ICD subsystem 202: is the primary user interface to the XLC system, as well as digital wireless services. It is physically configurable to appropriately support different operational modes encompassing hand-held (e.g. texting; surfing) and hands-free (e.g. sign-language) functions. In standard operational mode the ICD is similar in size to a cell phone
4. The IHuD subsystem 203 provides an additional mode of user interface to the XLC system, featuring multimedia display and eye-activated control via wireless link to the XLCC. It also provides an additional Z/TRAK input to the PPS. It may also include interface capabilities to, or integration of, other devices such as hearing aids.
5. Wireless Digital Services 204 is included to highlight XLC interface to external commercial systems. Interface between the XLC system and wireless digital services and products utilizes appropriate industry standard protocols. Wireless interface between XLCC and other XLC system modules may use proprietary protocols.

PPS Subsystem 201 drilldown: referring to FIG. 3/9, the function of the “On-Board” (OB) PPS subsystem is to wirelessly track and digitally encode the dynamics of critical anatomic “Glow Points” (GP) associated with the use of visual language (e.g. fingers, arms, face, head) in terms of Personal-Space Coordinates (PSC) based on positioning within a virtual Personal-Space Matrix (PSM), and to wirelessly provide that synchronized, encoded PSC data to a trans language conversion center (XLCC) for processing.

To facilitate the conversion process, as well as XLC system performance, “tagged” GPs (G/TAG) are grouped into tracking “zones” (e.g. right hand zone) based on the linguistics of the user's visual language (e.g. ASL). This allows the language conversion process to be handled modularly (relates to language layering), and in parallel.

Referring to FIG. 4/9, the PPS subsystem is comprised of the following major functional types:
1. G/TAG: the anatomic G/TAG 400 provides the foundation for the system capability of Digitally Encoded Motion (DEM) of visual-language. Each G/TAG is assigned a uniquely identifying digital code (GP/ID 401) that represents a corresponding anatomic GP. This includes, but is not limited to, fingers and hands, arms and shoulders, head and face, torso and legs. G/TAGs may be physical and/or virtual markers based on application requirements' and may include a broad range of technology types such as electronic (e.g. RFID, μ-transmitter, thin-films etc.), video (e.g. 2D, 3D, gray scale, etc.), and spectral (e.g. thermal, sonic, etc.), as well as commercial motion capture products.
2. PSM: a virtual “personal-space” matrix (PSM) referenced in FIG. 3/9 is created by the XLC system, providing a digital 3D grid for referencing G/TAG position coordinates. The PSM origin is created using an OB master datum (M/DTM). The PSM is a user-encompassing 3D virtual matrix providing a high resolution of G/TAG position, sufficient to differentiate language-significant positional changes. (e.g. 3000 unit resolution per axis provides 27 billion location pixels, translating into a DEM resolution of approximately 0.6 mm/0.024″ for a person 1.8 M/70.87″ in height). The XLC system features a user-executed, PPS self-calibration process that scales the PSM axis values to the specific XLC user to accommodate physical size variability, providing the means to normalize/neutralize the effect of this variability on system performance.
3. G/TRAK: the G/TAGs identify the anatomic points that are to be tracked within the PSM. Keyed on the GP type, G/TAG Trackers (G/TRAK) execute that tracking function via application of appropriate technology (e.g. triangulation, 3D digital video, etc.). G/TRAKs convert G/TAG motion into space-time coordinates based on position within the PSM at the time of “sampling”. Similar to the PSM unit resolution, the sampling rate of G/TAG positioning by G/TRAKs directly impacts the ability to differentiate Language-Significant Position changes (LSP), as well as determining the amount of PSC data that is transmitted. The XLC system accommodates at least three (3) sampling rates. These rates are 10, 100, and 1000 samples/second, with rate selection based on application. Every G/TRAK incorporates a G/TAG for position tracking redundancy and to calculate Zone Offset Coordinates (ZOC) for calibration, as well as for converting zone-space coordinates (ZSC) to personal-space coordinates (PSC). There are two (2) functional types of G/TRAKs, zone-base trackers (Z/TRAK) and master-base trackers (M/TRAK):
4. Z/TRAK: Z/TRAKs 402 are assigned G/TAGs based on the linguistics of the user's visual language (e.g. ASL). An example of a typical linguistic-related, G/TAG zone-grouping would include the five fingers on one hand. Utilizing appropriate tracking methodologies based on G/TAG type, the Z/TRAK tracks and records, at the designated sampling rate, the position of assigned G/TAGs in terms of zone-space coordinates (ZSC 403) using the OB, zone-based datum (Z/DTM) as the origin for the zone-space matrix (ZSM). The ZSM uses the same axis unit value that was determined for the PSM. The Z/TRAK has sufficient OB memory capacity to store multiple cycles of ZSC tracking data. Following each sampling cycle, the Z/TRAK serializes the zone-assigned G/TAG ZSCs into a Data-Packet (DP), concurrently adding a Z/TRAK Identifying Code (ZIC) header and a time stamp, and then wirelessly transmits the DP to the master-base tracker (M/TRAK 404).The number of active, digital input channels and related data transmission requirements are key factors in establishing the G/TAG capacity of a Z/TRAK. The G/TAG capacity of a Z/TRAK is configurable by incrementing the number of installed, digital input channel modules.
5. M/TRAK: The M/TRAK performs the same functions as the Z/TRAK, i.e. tracking the position of assigned G/TAGs, including Z/TRAK positions in terms of PSCs, using the OB master-based datum (M/DTM) as the origin for the PSM. It synchronizes DP transmissions from Z/TRAKs, as well as tracks and calculate Zone-Offset Coordinates (ZOC) of Z/DTMs. ZOC data is added to the DP/ZSC, providing data packets of PSCs 405. The M/TRAK maintains the integrity of the zone G/TAG groupings, wirelessly transmitting the DP/PSCs to the XLCC.

XLCC Subsystem 200 drilldown: The primary function of the XLCC subsystem is trans-language conversion, i.e. to bilaterally convert the XLC user's language (UL) and communication-participant(s) language (PL), in real time, and to provide appropriate wireless digital output for driving multi-media communication devices (e.g. ICD, IHUD, commercial devices, etc.).

For conversion from visual language (VL), the XLCC utilizes the PPS generated space-coordinates data stream as an input and, via permutations of Configuration Mapping (CM), Language Layering (LL) and Digital Language Dictionaries (DLD), converts visual language dynamics into the language of the receiving communication-participant(s).

The conversion from verbal language follows a similar process, utilizing the user's digital audio input as the data source for conversion.

The VL conversion process described below represents encompassing aspects of the trans-language conversion process, visual or verbal.

Similar to most structured languages, formal visual languages have rules defining how words are combined into phrases and phrases into sentences. Associated attribute-modifiers (e.g. context, visual inflexions) are layered onto this structure, influencing the meaning of the intended communication (e.g. intensity, mood, etc.) and therefore it's' holistic conversion.

Similarly, when defining the meaning of a word, most structured languages include appropriate spelling and pronunciation. In the case of visual-language words, “pronunciation” is defined in terms of a sequence of anatomic motions involving one or more physical actions by the user.

The XLC system utilizes a Digital Anatomic Definition (DAD) of this sequence to convert visual-language anatomic motion into visual-language words (and vice versa), providing the foundation for subsequent conversion to another language.

XLCC: XLC Standards, Referring to FIG. 5/9

The key building block for this DAD is a pre-mapped, finite set of standard, Language-Significant Positions (LSP) for each GP (e.g. the full range, 3D motion for the right index finger may be divided into 10 LSPs).

Each LSP is defined in terms of a unique set of Standard-Position Coordinates (SPC 500) that are referenced to a standard datum (Z/DTM &/or M/DTM) within a standard PSM. Each LSP is assigned a unique Enabled-Position Code (GP/EPC). The SPC is used as the basis to convert GP/ZSC from the XLC user into GP/EPC, and vice versa. The GP/SPCs are expressed in generic units, allowing PSM axis scale to be set during user self-calibration.

Each enabled permutation of GP/EPCs 501 within a GZ is assigned a Configuration Identification Code (GZ/CIC 502). This approach establishes a finite set of possible glow-zone based, glow-point position configurations within the specific GZ and enables a configuration mapping approach to EPC to CIC conversion and vice versa. A specific GP/EPC may be contained in many different CICS, but the specific GP/EPC set is unique for a specific CIC.

The XLC Visual-Language DAD Dictionary (VL/DADD) contains codes for the defined anatomic motion of each Visual-Word as a sequence of synchronous Digital Anatomic-Motion Snapshot (DAMS 503). Each sequentially ordered DAMS contains a set of GZ/CICs that maps the location requirements of every GP (i.e. GP/EPC) in the PPS. The complete set or ordered DAMS represents the anatomic manifestation of the VW and is referenced in the XLC VL/DADD by its Word Identification Code (VL/WIC). Since the definition of a VW is expressed as a synchronous series of DAMS, the total number of DAMS varies from VW to VW based on the length of “pronunciation”.

The WIC provides the foundation for the conversion of words between languages.

The permutation tables and DAD dictionary utilized for VL language conversion are a representative subset of the XLC library of Digital Language Dictionaries and conversion tables. The XLCC utilizes the VL architectural approach as the structure for digital encoding of verbal languages, utilizing the sequenced digital data stream output from a digital voice analyzer to initiate the conversion sequence to PL.

XLCC: PPS Output (GP/PSC) Conversion to Glow Zone Configuration Codes (GZ/CIC), Referencing FIG. 6/9

Utilizing established standards, the XLCC process can be grouped into three major conversion steps, with language-layering conversion extensions: Step 1—GP/PSC to GZ/CIC; Step 2—GZ/CIC to VL/WTC; Step 3 VL/WTC to PL/WTC.

Regarding Step 1, GP/PSCs are received in DP format 600 from M/TRAK. The serial DP GP/PSC data is converted to parallel data for “snapshot” XLCC processing. The parallel data is grouped into Time Packets (TP 601) by the TP sequence generator 609, with each TP containing 10 sequential sets of PSC data for each GP, grouped by GZ (10 DP=1 TP).

An algorithm converts the (10) ZSC value-sets, and related ZOC value-sets, contained within the TP data to (1) value representing the group. Via a mapping process, the normalized ZSC values are converted to the appropriate Standard Position Coordinates (SPC 602), utilizing the XLC ZSC/SPC 608 conversion table standards.

The DP input to this process step may be used as an output to an XLC, Digital Video Driver (DVD) for high-resolution, unedited video feedback for the XLC system user. The TP output from this process may be fed to an XLC, Digital Video Driver (DVD) for normal-resolution, edited video feedback for the XLC system user. In a reverse XLC process, i.e. PL to VL, the SPC values may be used for output to an XLC, Digital Video Driver (DVD) for presentation of an animated video version (e.g. ASL) of the PL communication.

To further reduce the data handling requirements, the value set of each SPC is converted to a single code, the Enabled Position Code (EPC 603), utilizing the XLC SPC/EPC conversion table standards.

The set of EPCs is used to identify the unique, corresponding Configuration Identification Code (CIC 604), utilizing the XLC EPC/CIC conversion table standards. The output from this process step, i.e. GZ/CIC set, represents (1) Personal Anatomic Motion Snapshot (PAMS 605) of the XLC system user. With a frequency factor of 100 ZSC values/sec, the system will be processing (10) PAMS/sec.

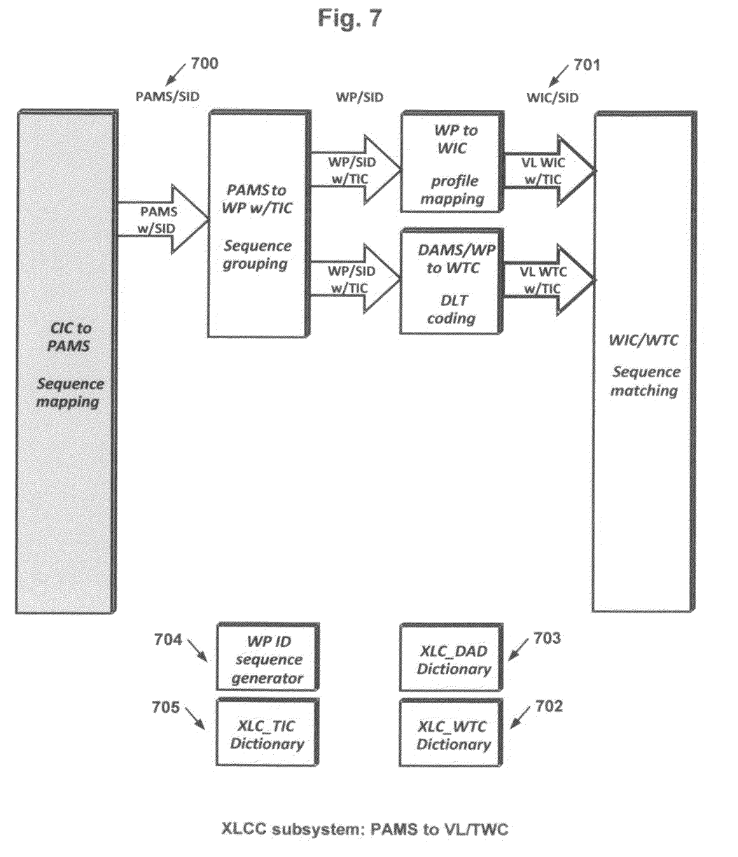

Regarding Step 2: GZ Configurations (GZ/CIC) to Word Codes (VL/WTC), referring to FIG. 7/9

The output from Step 1, i.e. PAMS with Sequence Identification numbers (PAMS/SID 700), is grouped into Word Packets (WP 704) based on VL transition indicator syntax, with each WP assigned Transition Indicator Codes (TIC 705) that identify the role of the VL word relative to other words at (3) distinct levels of transition, i.e. start/stop of word, start/stop of phrase and start/stop of sentence. This provides (3) levels of language conversion capability: word to word; phrase to phrase; sentence to sentence. The TICs for each language are contained in the XLC library.

With the PAMS grouped into words, the XLCC uses a profile mapping algorithm to match the WP to the associated Word Identification Code (WIC 701) in the DADD 703. This provides a literal conversion of the VL word. Concurrently, intra-word dynamics are identified in terms of word texturing codes (WTC 702) providing word conversion with word level language dynamics. The combination of the WIC and WTC is referred to as a Textured Word Code (TWC).

The output from this process may be fed to an XLC, Digital Text Driver (DTD) and/or an XLC, Digital Voice Synthesizer (DVS) for user feedback applications.

The VL/TWC data is utilized in the next process sequence for conversion to the communication Participants' Language (PL).

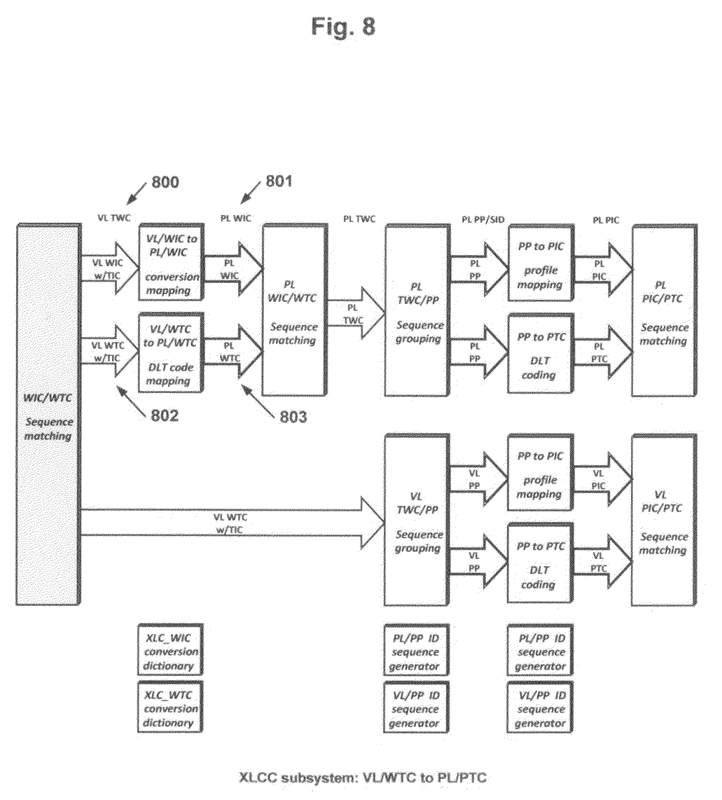

XLCC: VL Textured Word Code (VL/TWC) to PL Textured Word Code (PL/TWC) and Textured Phrase Code (VL/TPC; PL/TPC), Referring to FIG. 8/9

Utilizing the XLC WIC multi-language DLD, the output from Step 2, i.e. VL/WIC with Sequence Identification numbers (VL TWC/SID 800), is mapped to the corresponding PL/WIC 801. The VL/WTC 802 component is mapped to its equivalent P/WTC 803, to equate the communication dynamics of the two engaged languages

The output from this process (PL/TWC) may be fed to an XLC, Digital Text Driver (DTD) and/or an XLC, Digital Voice Synthesizer (DVS) for presentation of the converted word in PL.

Combining word-level output with phrase-level TIC and texturing codes (PTC) provides phrase-level conversion of the engaged languages. Similarly, combining phrase-level components provides sentence-level conversion of the engaged languages (not shown).

This completes the language conversion from VL to PL. The XLCC provides an output digitally formatted for digital voice synthesizing, transmitted wirelessly to the ICD subsystem.

ICD Subsystem, referring to FIG. 9/9

The ICD subsystem is the primary user interface to the XLC system, as well as digital wireless services. ICD receives input from the XLCC (e.g. DVD; DTD; DVS) for multi-media display and incorporates all functionality currently available on mobile digital devices such as cell phones.

It is physically configurable to appropriately support different operational modes encompassing hand-held (e.g. texting; surfing) and hands-free (e.g. sign-language) functions. In basic operational mode the ICD is similar in size to a cell phone.

There are three operational modes to accommodate varying communication settings, providing physical configuration alterations for each mode.

Mode I 900 is the most compact and provides basic hand-held operation commonly available on digital telecom devices.

Mode II 901 can also be used for hand-held operation and deploys a second touch-screen configured as a soft keyboard, providing a larger text input interface for the XLC user.

Mode III 902 is a hands-free operation, deploying a third screen for larger viewing and a stabilizing extension to provide a base for setting the device onto a surface. The ICD may also incorporate 3D cameras, providing G/TRAK capabilities into the PPS.

Hands-free bilateral communication is available for use in all modes.

What I claim as my invention is:

1. Method and system apparatus that enables Deaf and Hard of Hearing (DHH) individuals communicating using a visual language (e.g. American Sign Language) to directly and bilaterally converse with their hearing counterparts communicating with a verbal language (e.g. English) and to able to do so anytime, anywhere, comprised of but not limited to:
a. A mobile, “on-board” (i.e. worn by user) motion capture apparatus, which tracks, encodes and wirelessly transmits visual-language related motion to an “on-board” trans-language processing device.
b. An “on-board” virtual personal positioning matrix, utilizing “on-board” datum markers as reference for position-coordinate encoding.
c. A trans-language conversion methodology and device that provides proficient processing of visual language conversion to verbal language equivalents, and vice versa, via a modular, zone based parallel processing and conversion methodology.
d. A digital interface display capable of providing text, digital sign, and video for DHH users
e. An integrated speech recognition and voice synthesizer device facilitating verbal language interface requirements.

2. Method and apparatus that enables DHH users to conduct hands-free, bilateral trans-language conversation via a wrist-mounted interactive display device and related software.

3. Method and apparatus that provides an “All-In-One” personal communication device for DHH individuals via incorporation of smart phone capabilities and an interactive, multimedia interface device.
